(19) United States
(12) Patent Application Publication
(10) Pub. No.: US 2007/0113719 A1
(43) Pub. Date: May 24, 2007

(54) Sound box for floor-standing string instrument

(75) Inventors: Roger Hsu, Taipei (TW); Daniel Yeh, Taipei (TW)

Correspondence Address: TROXELL LAW OFFICE PLLC, SUITE 1404, 5205 LEESBURG PIKE, FALLS CHURCH, VA, 22041, US

(73) Assignee: OTTO MUSICA CORPORATION

(21) Appl. No.: 11/481,903

(22) Filed: Jul. 7, 2006

(30) Foreign Application Priority Data
Nov. 21, 2005 (TW) 094220127

(51) Int. Cl. G10D 3/00

(52) U.S. Cl. 84/291

(57) ABSTRACT

A sound box for floor-standing string instrument includes a resonance box being provided on a top surface with at least one recess for receiving a spike below the string instrument therein, and an opening extended through the top surface of the resonance box; and a pad attached to a bottom surface of the resonance box. The resonance box and the pad together form a sound reflection controlling mechanism, so that vibration waves transmitted from the string instrument to the sound box are reflected back to the string instrument. The reflected sound waves combine with the original vibration waves to amplify the sound produced by the string instrument, making the sound more brilliant and sweeter.

### FIELD OF THE INVENTION

The present invention relates to a sound box for floor-standing string instrument, and more particularly to a sound box that could be associated with a musical instrument, such as a string instrument, to further change the resonance of the musical instrument and enhance the tone color of sound produced by the musical instrument.

### BACKGROUND OF THE INVENTION

When playing a cello, for example, a lower part of the cello is usually clamped between the player's two knees, and a neck of the cello is rested on the player's one shoulder. The cello is provided at a lower end with a retractable spike for supporting the cello over a floor surface. To avoid the cello from sliding on the floor surface when being played and causing difficulties during performance, the spike is usually positioned on a spike locator provided on the floor surface.

FIGS. 1 and 2 are perspective and sectioned side views, respectively, of a conventional spike locator for the spike of a cello. As shown, the spike locator basically includes a long plate A, on which at least one limiting hole A1 is formed for the spike to rest therein. The long plate A is connected at an end to a length-adjustable belt A2, which is further connected at an opposite end to a locating plate A3. For the purpose of forming better tone color, the long plate A is generally made of a wooden material, such as rose wood. The long plate A is also provided at a bottom surface with antiskid pads A4, which provides an increased friction force against the floor surface. The locating plate A3 is held in place using a chair leg, so that the cello spike locator is not subject to moving easily.

However, such spike locator is generally intended for preventing the cello from sliding when being played, and does not function to enhance the tone color of the cello.

### SUMMARY OF THE INVENTION

A primary object of the present invention is to provide a sound box for floor-standing string instrument. The sound box is able to resonate with a string instrument disposed thereon to further enhance the brilliance and sweetness of sound produced by the string instrument.

Another object of the present invention is to provide a sound box for floor-standing string instrument. The sound box is provided at a bottom surface with a pad, which increases a friction between the sound box and a floor surface to prevent a string instrument disposed on the sound box from undesired sliding.

A further object of the present invention is to provide a sound box for floor-standing string instrument. The sound box is provided at a bottom surface with a pad, so that the shape of the sound box and the thickness of the pad cooperate to change the resonance of sound produced by a string instrument disposed on the sound box.

To achieve the above and other objects, the sound box for floor-standing string instrument according to the present invention includes a resonance box being provided on a top surface with at least one recess for receiving a spike below the string instrument therein, and an opening extended through the top surface of the resonance box; and a pad attached to a bottom surface of the resonance box for stably holding the sound box to the floor surface via a friction force. The sound box may be of any shape.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional cello spike locator;

FIG. 2 is a fragmentary sectioned side view of FIG. 1;

FIG. 3 is a perspective view of a sound box for floor-standing string instrument according to a preferred embodiment of the present invention;

FIG. 4 is a sectioned side view of FIG. 3;

FIG. 5 is a perspective view showing a string instrument is disposed on a sound box of FIG. 3;

FIG. 6 is a fragmentary and enlarged view of FIG. 5;

FIG. 7 is a perspective view of a sound box for floor-standing string instrument according to another embodiment of the present invention;

FIG. 8 is a fragmentary and enlarged sectioned side view of FIG. 7; and

FIG. 9 is a perspective view showing a string instrument is disposed on a sound box of FIG. 7.

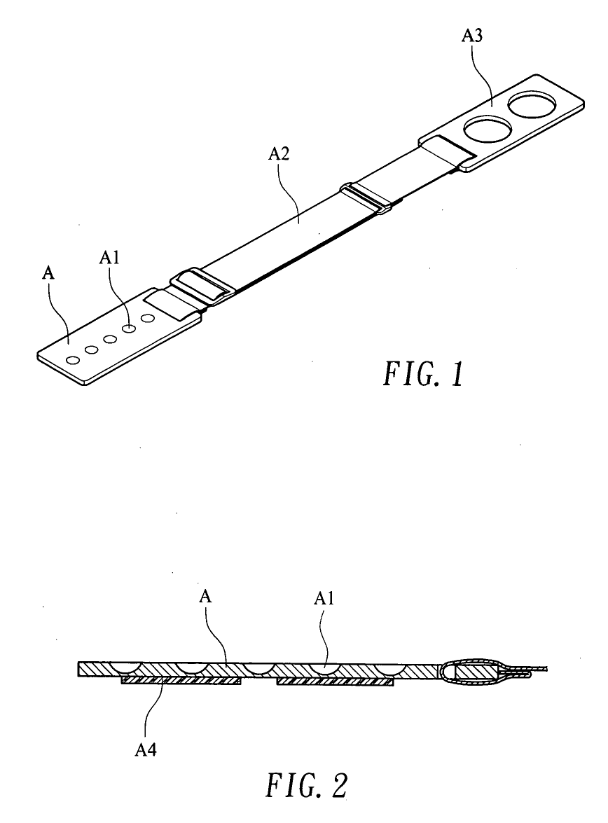

### DETAILED DESCRIPTION OF THE PREFERRED EMBODIMENTS

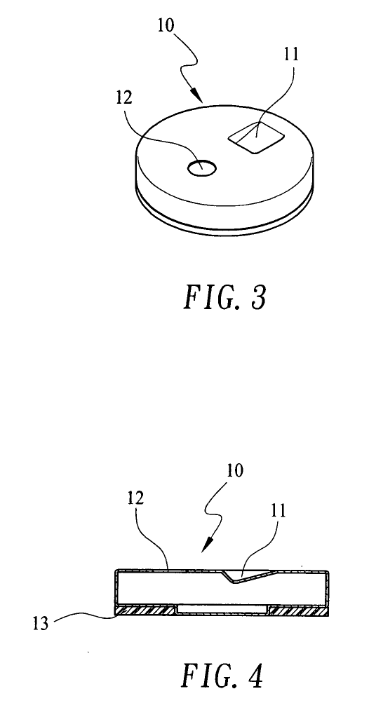

Please refer to FIGS. 3 and 4 that are perspective and sectioned side views, respectively, of a sound box for floor-standing string instrument according to a preferred embodiment of the present invention. As shown, the sound box 10 is a resonance box being provided on a top surface with at least one recess 11 and an opening 12 extended through the top surface of the sound box 10. A pad 13 is attached to a bottom surface of the sound box 10. The pad 13 functions like a sucker to tightly hold the sound box 10 to a floor surface. While the sound box 10 in the illustrated preferred embodiment is a round box, it may be other suitable geometrical shapes.

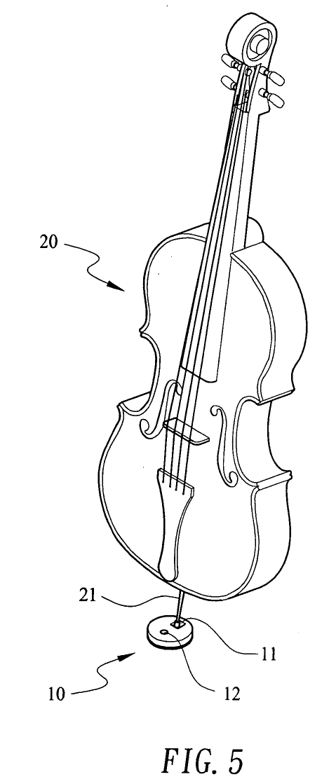

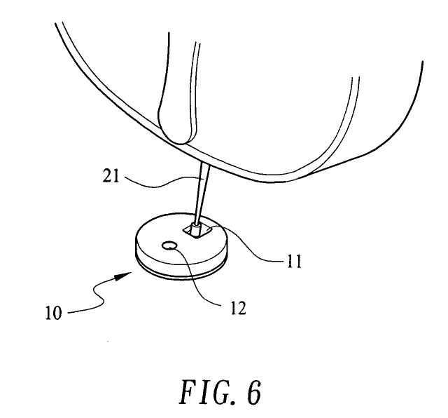

Please refer to FIGS. 5 and 6. The sound box 10 is positioned on a floor surface. A floor-standing string instrument 20 may be disposed over the sound box 10 with a spike 21 of the string instrument 20 inserted in the recess 11. When a performer plays the string instrument 20, sound produced by a vibrating belly of the string instrument 20 is transmitted via the spike 21 to the sound box 10, so that sound waves vibrate and are continuously reflected in the sound box 10. With a sound reflection controlling mechanism formed from the sound box 10 and the pad 13 below the box 10, the vibration waves transmitted from the belly of the string instrument 20 are reflected to the belly and combined with the original vibration waves to produce resonance, and thereby changes the original sound produced by the string instrument 20. That is, the sound originally produced by the string instrument 20 is enhanced through resonance with the sound box 10.

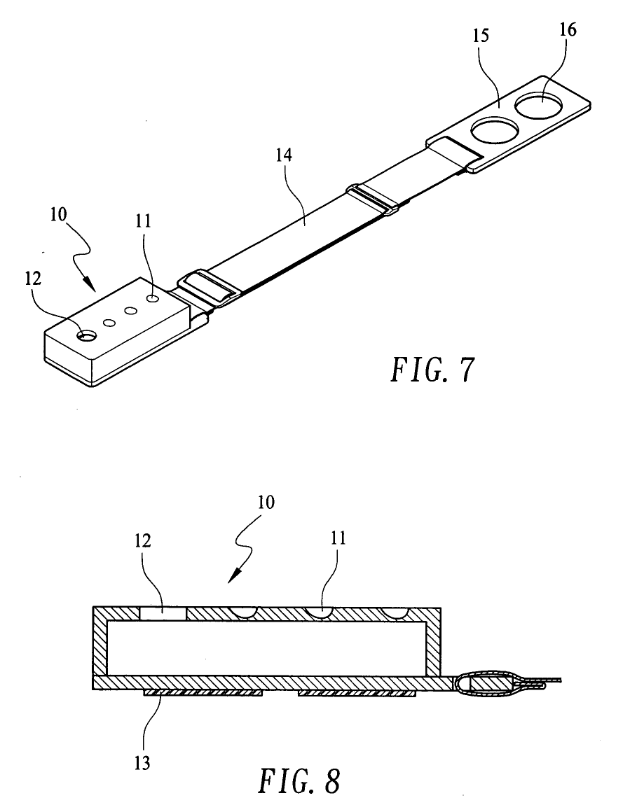

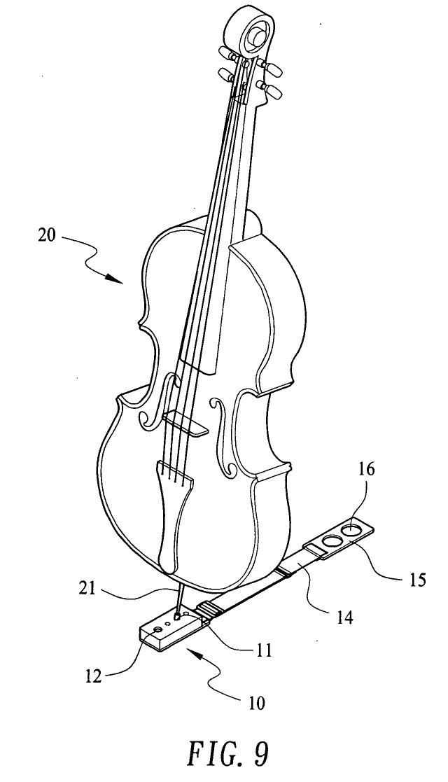

FIGS. 7 through 9 show a sound box 10 for floor-standing string instrument according to another embodiment of the present invention. The sound box 10 in the second embodiment is connected at an end to a length-adjustable belt 14, which is connected at an opposite end to a locating plate 15. The locating plate 15 is provided at predetermined position with at least one locating hole 16. When a performer sits on a chair (not shown) to play the string instrument 20, a leg of the chair is engaged with one locating hole 16 on the locating plate 15 to restrict the belt 14 and accordingly, the sound box 10 from moving. With a geometrical structure formed from the sound box 10 and the pad 13 located below the sound box 10, the vibration damping is changed. And, the sound produced by the string instrument 20 is adjusted by changing the vibration mode of the string instrument 20.

In the past time, the only ways to change the sound produced by a musical instrument are changing the structure of the musical instrument, or selecting other more suitable strings for the instrument, or externally adding other device to the instrument. Now, the present invention provides the string instrument performer a new way to amplify the sound produced by the instrument without the need of changing the structure of the instrument or mounting an additional device on the instrument. With the present invention, the sound produced by the string instrument becomes much sweeter.

In addition to the intended antiskid function, the sound box 10 and the pad 13 also together form a sound damper, so that the sound produced by the string instrument 20 through vibration is reflected back to the string instrument 20. The reflected sound combines with the original sound to enhance the sound effect of the string instrument 20, so that the produced sound is more brilliant and sweeter.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A sound box for floor-standing string instrument, comprising a resonance box being provided on a top surface with at least one recess for receiving a spike below a string instrument therein, and an opening extended through the top surface of said resonance box; and a pad attached to a bottom surface of said resonance box.

2. The sound box for floor-standing string instrument as claimed in claim 1, wherein said resonance box may be of any shape.

3. The sound box for floor-standing string instrument as claimed in claim 1, wherein said resonance box is connected at an end to a length-adjustable belt, and said belt is connected at an opposite end to a locating plate.

4. The sound box for floor-standing string instrument as claimed in claim 3, wherein said locating plate is provided with at least one locating hole.
